(19) United States
(12) Patent Application Publication
(10) Pub. No.: US 2023/0408010 A1
(43) Pub. Date: Dec. 21, 2023

(54) PLUG-TYPE PIPE CONNECTION

(71) Applicant: Östliche Karl-Friedrich-Strasse 134, Pforzheim (DE)

(72) Inventors: David EHRENBERGER, Königsbach-Stein, DE (US); Alexander LEIPPI, Pforzheim (DE)

(73) Assignee: Östliche Karl-Friedrich-Strasse 134, Pforzheim (DE)

(21) Appl. No.: 18/332,046

(22) Filed: Jun. 9, 2023

(30) Foreign Application Priority Data
Jun. 13, 2022 (DE) 102022114846.7

(51) Int. Cl. F16L 37/086

(52) U.S. Cl. CPC F16L 37/086

(57) ABSTRACT

A plug-type connection (1) having an inner pipe (2) and an outer pipe (3), which outer pipe (3) is plugged with one of end thereof onto one end of the inner pipe (2). The plug-type connection (1) has a spring element (4) arranged on the outside of the inner pipe (2) in the region of the end thereof, and the outer pipe (3) has a first widened portion (3a) at that end, in a region of which the outer pipe (3) is spaced apart (A) from the inner pipe (2) and engages over the spring element (4). The outer pipe (3) has an engagement structure (3b) in the region of the first widened portion (3a), with which engagement structure (3b) the spring element (4) is in engagement.

### CROSS-REFERENCE TO RELATED APPLICATIONS

This application claims priority to German Patent Application No. 10 2022 114 846.7, which is incorporated herein by reference as if fully set forth.

### TECHNICAL FIELD

The invention relates to a plug-type connection with an inner pipe and with an outer pipe, which outer pipe is plugged with one of its ends onto one end of the inner pipe.

### BACKGROUND

Releasable plug-type pipe connections with an outer safety clamp are known from the prior art.

The outer safety clamp requires installation space and carries of the risk of injury as a result of sharp edges and snagging during handling. Moreover, it is possible that a possibly additionally present sealing element is adversely affected during joining.

### SUMMARY

The invention is based on the object of specifying a plug-type (pipe) connection of the stated type with a concealed securing function, which plug-type (pipe) connection overcomes the stated disadvantages and can preferably be assembled and dismantled manually. It should ideally be possible for the securing means or securing function to be monitored visually or tactilely.

According to the invention, the object is achieved by a plug-type connection or plug-type pipe connection with one or more of the features disclosed herein.

Advantageous developments of the invention are defined below and in the claims.

In the following text, the terms plug-type connection and plug-type pipe connection are used as synonyms.

According to the invention a plug-type connection with an inner pipe and with an outer pipe, which outer pipe is plugged with one of its ends onto one end of the inner pipe, is distinguished by the fact that a spring element is arranged on the outside of the inner pipe in the region of its said end; the outer pipe has a first widened portion at its said end, in the region of which first widened portion the outer pipe is spaced apart from the inner pipe and engages over the spring element; and the outer pipe has an engagement structure in the region of the first widened portion, with which engagement structure the spring element is in engagement.

On account of the fact that the outer pipe engages with its widened portion over the spring element, which spring element provides the addressed securing function by way of its engagement with the engagement structure, the disadvantages of the prior art can be avoided, in particular the risk of injury by sharp edges and snagging during handling.

The following developments of the plug-type connection according to the invention have proven to be particularly advantageous in practice.

A first development of the plug-type connection according to the invention provides that, in the region of its said end, the inner pipe has an outer fastening structure for fastening the spring element. In this way, the spring element can already be connected to the inner pipe beforehand, which facilitates the handling.

A second development of the plug-type connection according to the invention provides that the fastening structure is configured as at least one holding bead. A fastening structure of this type can be produced particularly simply ad inexpensively.

Another development of the plug-type connection according to the invention provides that the at least one holding bead is configured to the inside in the radial direction. In this way, the fastening structure does not project at all or projects only a little to the outside with respect to the inner pipe, which can be advantageous, in particular, in a state in which the plug-type pipe connection is not yet connected.

In contrast, yet another development of the plug-type connection according to the invention provides that the at least one holding bead is configured to the outside in the radial direction. In this way, the fastening structure, in particular, does not bring about any reduction in the clear internal cross section of the inner pipe.

A further development of the plug-type connection according to the invention provides that the spring element is latched elastically into the fastening structure. This enables particularly simple and inexpensive production of the plug-type pipe connection and the inner pipe including the spring element. In this context, the spring element can be applied to the inner pipe both radially and axially.

Another development of the plug-type connection according to the invention is distinguished by the fact that the spring element is bent over axially in a connected state of the inner pipe and the outer pipe. In this way, the spring element is situated in a tensioned state, with the result that it ensures efficient securing of the plug-type connection when it engages into the engagement structure.

In order to achieve a sufficient seal of the plug-type connection, yet another development of the plug-type connection according to the invention provides that at least one sealing element, in particular an O-ring, is arranged between the inner pipe and the outer pipe.

In a further development of the plug-type connection according to the invention, it has proven to be particularly advantageous if the sealing element is received in a peripheral shaped-out formation of the outer pipe, which shaped-out formation is arranged outside the first widened portion, preferably in the region of a second widened portion. This ensures that damage of the sealing element cannot occur during joining of the inner pipe and the outer pipe for the purpose of establishing the plug-type connection.

A further development of the plug-type connection according to the invention is distinguished by the fact that an internal diameter of the outer pipe in the region of the second widened portion corresponds substantially to an external diameter of the inner pipe. This notably contributes to the sealing action, already mentioned further above, being achieved.

In contrast, one alternative embodiment of the plug-type connection according to the invention provides that the sealing element is arranged in a holding structure which is configured on the inner pipe, preferably in the form of a holding bead.

In order to simplify the production and, in particular, to configure it to be inexpensive, one development, building on this, of the plug-type connection according to the invention is distinguished by the fact that the holding structure is formed in part by way of the fastening structure mentioned further above, in particular the holding bead which is configured outward in the radial direction. In this context, the configuration of a double holding bead is particularly advantageous, which receives firstly the spring element and secondly the sealing element.

One extremely preferred development of the plug-type connection according to the invention is distinguished by the fact that the engagement structure is configured as an aperture in the outer pipe. In this way, the engagement of the spring element into the engagement structure is visible from outside and can be checked accordingly.

An alternative development of the plug-type connection according to the invention is distinguished by the fact that the engagement structure is configured as a radial bulge of the outer pipe. In this way, the engagement structure is protected from harmful effects from the outside, in particular from contamination.

One extremely preferred development of the plug-type connection according to the invention is distinguished by the fact that the spring element protrudes axially beyond the outer pipe. This also makes at least visual checking of the securing function possible in an advantageous way.

One particularly advantageous development of the pug-type connection according to the invention is distinguished by the fact that the spring element has, starting from the fastening structure, first of all a first portion with a (substantially) radial course, then a second portion, in which second portion it is in engagement with the engagement structure, and subsequently a third portion, with which third portion it protrudes out of the outer pipe, as has already been mentioned further above. Here, the spring element is preferably arranged in such a way that a movement of the third portion in the direction of the inner pipe, for example by way of manual pressure, frees the second portion from its engagement with the engagement structure. The spring element therefore acts as a type of elastic securing lever and makes simple dismantling of the plug-type connection possible.

Another, particularly advantageous development of the plug-type connection according to the invention is distinguished by the fact that the outer pipe can be pushed with its said end onto said end of the inner pipe in the axial direction, it being possible for the spring element to be bent over in the axial direction and, when a connected position is achieved, forming an elastically joinable snap-action connection with a positively locking connection in conjunction with the engagement structure. A plug-type connection of this type can be handled particularly simply and securely. On account of the elastically joinable snap-action connection with a positively locking connection, which positively locking connection is established by the engagement of the spring element into the engagement structure, the plug-type connection can be simply assembled and dismantled again; in particular, if the spring element is configured as an elastic securing lever, as described further above.

In order to facilitate the joining process, another development of the plug-type connection according to the invention is distinguished by the fact that the inner pipe terminally has an insertion bevel at its said end, in particular in the form of a tapered portion at least of its external diameter.

It has proven advantageous for the practical use, in particular in the automotive sector, if the inner pipe and the outer pipe are configured from a metallic material, preferably steel or stainless steel.

A satisfactory dismantling capability of the plug-type connection can also be achieved by virtue of the fact that, in the course of another development of the plug-type connection according to the invention, the outer pipe is terminally bent back on itself axially at its said end, a radial spacing remaining between a relevant bent-back portion of the outer pipe and a portion of the outer pipe. An action of, in particular, manual pressure on said bent-back portion can then lead to the outer pipe widening at least in the region of the engagement structure, with the result that the inner pipe together with the spring element can then be pulled out of the outer pipe.

In summary, it is accordingly proposed to configure a plug-type pipe connection, preferably with an integrally molded sealing element seat, in such a way that the fastening structure for a spring element (for example, in the form of a holding bead) is formed on the inner pipe, in which fastening structure a spring element is fastened, in particular is latched elastically. The spring element is preferably constructed in such a way that it is bent over in the axial direction from the fastening structure or a latching seat, and forms a preferably elastically joinable snap-action connection with a positively locking connection in conjunction with the sleeve pipe (outer pipe), said snap-action connection representing one specific embodiment of said engagement into the engagement structure.

Therefore, a plug-type (pipe) connection is proposed, inter alia, with an inner pipe and with an outer pipe, which outer pipe is plugged with one of its ends onto one end of the inner pipe or can be plugged on in order to establish the connected state, a clear internal diameter of the outer pipe in the region of its said end preferably corresponding substantially to an external diameter of the inner pipe, which plug-type connection is distinguished by the fact that, in the region of its said end, the inner pipe has an outer fastening structure for fastening a spring element, in which fastening structure spring means is arranged, which spring means protrudes in the radial direction by a first amount from the inner pipe in a state of the inner pipe and the outer pipe in which they are not connected; at its said end, the outer pipe has a widened portion, in the region of which widened portions of the outer pipe is spaced apart from the inner pipe by a second amount in the connected state; the first amount is greater than the second amount, with the result that, when the outer pipe is plugged with its said end onto said end of the inner pipe, the spring element is tensioned in the direction of the inner pipe; and the outer pipe has an engagement structure in the region of the widened portion, into which engagement structure the spring element engages in the connected state while at the same time being relieved.

The corresponding embodiments, described further above, of the invention ensure, in particular, that there is no risk of damage of the sealing element during the joining process.

Within the context of the invention, there is only a slight probability of catching as a result of the concealed embodiment of the securing function.

Centering of the (plug-type) connection advantageously takes place during joining before contact with the sealing element, in particular of the O-ring, with the outer pipe.

### BRIEF DESCRIPTION OF THE DRAWINGS

Further properties and advantages of the invention result from the following description of exemplary embodiments on the basis of the drawing, in which:

FIG. 1 shows a longitudinal section of a first embodiment of the plug-type connection according to the invention,

FIG. 2 shows a longitudinal section of a second embodiment of the plug-type connection according to the invention,

FIG. 3 shows a longitudinal section of a third embodiment of the plug-type connection according to the invention,

FIG. 4 shows a longitudinal section of a fourth embodiment of the plug-type connection according to the invention, and

FIG. 5 shows a longitudinal section of a fifth embodiment of the plug-type connection according to the invention.

### DETAILED DESCRIPTION

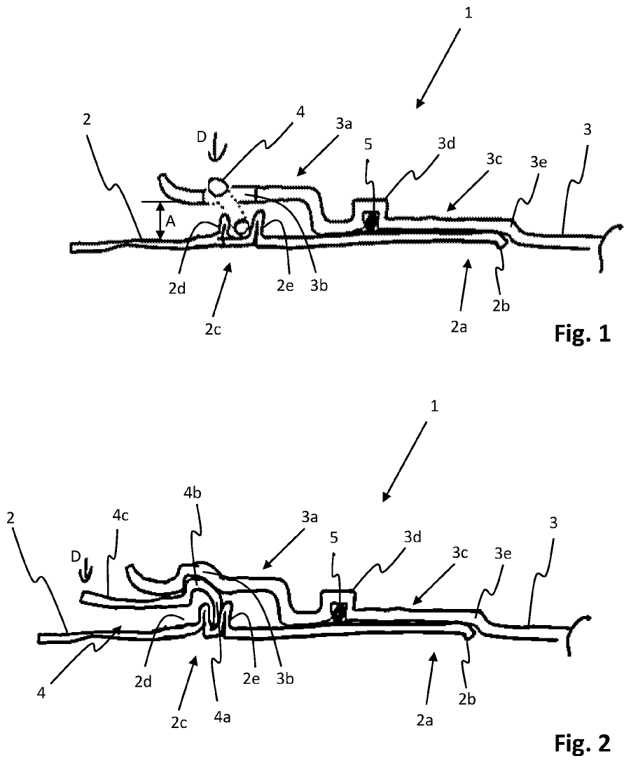

FIG. 1 shows a longitudinal section of a first embodiment of the plug-type connection according to the invention, only one half of the plug-type connection according to the invention always being shown here (as is also the case in all the other figures) on account of symmetry with regard to a longitudinal axis of the plug-type connection.

The plug-type connection is denoted overall by the designation 1. It comprises an inner pipe at designation 2 and an outer pipe at designation 3. At its end 2a which is introduced into the outer pipe 3, the inner pipe 2 has a tapered portion 2b which acts as an insertion bevel. Furthermore, the inner pipe 2 has a fastening structure 2c for a spring element 4, which fastening structure 2c is configured in the form of a radially outwardly configured holding bead. The holding bead comprises two axial bulges 2d, 2e, spaced apart from one another, of the inner pipe 2, between which bulges 2d, 2e the spring element 4 is fastened. The spring element 4 protrudes in the radial direction with respect to the inner pipe 2.

The outer pipe 3 has a first, terminal widened portion 3a, with which it engages over the inner pipe 2 in the region of the fastening structure 2c and correspondingly also engages over the spring element 4, the outer pipe 3 being spaced apart from the inner pipe 2 in the region of the widened portion 3a by an amount A. Said amount A is greater than the radial dimension of the bulges 2d, 2e, but is smaller than an amount, with which the spring element 4 protrudes with respect to the inner pipe 2.

In the region of the first widened portion 3a, moreover, the outer pipe 3 has an engagement structure 3b for the spring element 4, which engagement structure 3b is configured, in accordance with the embodiment in FIG. 1, has an aperture in the outer pipe 3. An embodiment of this type makes visual checking of the securing function possible.

The outer pipe 3 also has a second widened portion 3c which is arranged adjacently with respect to the first widened portion 3a. In the region of the second widened portion 3c, the outer pipe 3 is configured or widened in such a way that its clear internal diameter corresponds substantially (that is to say, apart from usual tolerances) to an external diameter of the inner pipe 2. In the region of the second widened portion 3c, furthermore, the outer pipe has a peripheral shaped-out formation 3d, in which a sealing element 5 in the form of an O-ring is arranged.

In the region of its tapered portion 2b, the inner pipe 2 bears against the shoulder 3e of the outer pipe 3, which shoulder 3e delimits the second widened portion 3c.

For the purpose of establishing the plug-type connection 1 which is shown in FIG. 1, the outer pipe 3 is pushed or plugged with its first widened portion 3a onto the inner pipe 2 from the right, the spring element 4 being bent over axially to the left and correspondingly being tensioned. As soon as the outer pipe 3 arrives at the engagement structure 3b or the corresponding aperture at the spring element 4, the latter springs back into its (rest) position shown in FIG. 1, and is thus in engagement with the engagement structure 3b. The plug-type connection 1 is therefore secured.

By way of an action of force on the spring element 4 according to the arrow D in FIG. 1, the spring element 4 can be freed from an engagement with the engagement structure 3b, in order to release the plug-type connection 1 again.

The following FIGS. 2 to 5 show further embodiments of the plug-type connection 1 according to the invention in drawings. Identical designations denote identical or at least identically acting elements in all the figures. In the following description of the further exemplary embodiments, the differences from the embodiment according to FIG. 1 will substantially be described in greater detail. It is possible that not all elements are denoted again in FIGS. 2 to 5.

The embodiment according to FIG. 2 differs from the embodiment according to FIG. 1 only in terms of the type of the spring element 4 and the engagement structure 3b.

According to FIG. 2, the spring element 4 is configured in such a way that, in the longitudinal section which is shown, it first of all has, starting from the fastening structure 2c, a first portion 4a with a substantially radial course, by way of which first portion 4a it is fixed in the fastening structure 2c. This is adjoined by a second portion 4b, in which second portion 4b the spring element 4 is arched up radially and is in engagement with the engagement structure 3b of the outer pipe 3. Said engagement structure 3b is configured here as a matching radial bulge of the outer pipe 3. Subsequently, the spring element 4 has a third portion 4c, with which third portion 4c it protrudes out of the outer pipe 3. In this way, the spring element 4 is configured arranged in such a way that a movement of the third portion 4c of the spring element 4 in the direction of the inner pipe 2, for example by way of the action of manual pressure according to arrow D, frees the second portion 4b of the spring element 4 from its engagement with the engagement structure 3b. The plug-in connection 1 can therefore be released again easily.

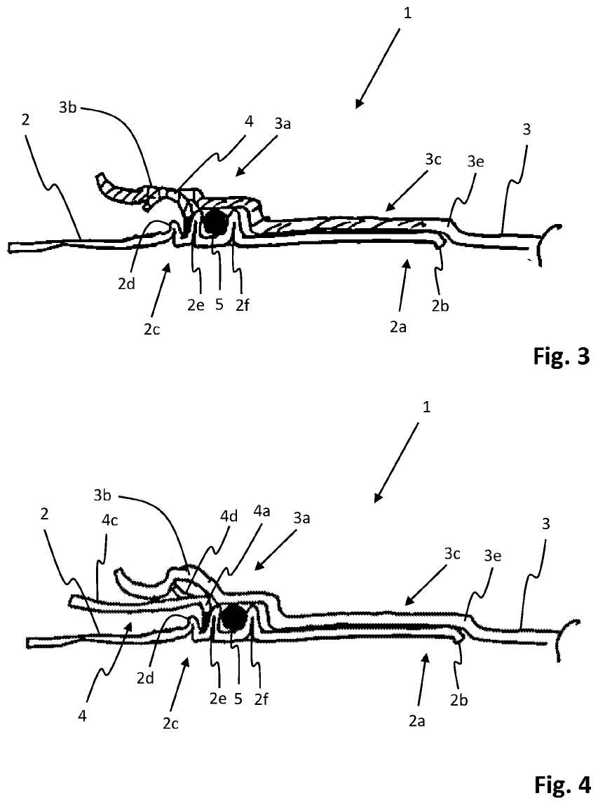

With regard to the spring element 4 and the engagement structure 3b, the embodiment of the plug-type connection 1 according to FIG. 3 corresponds substantially to the embodiment according to FIG. 1. One substantial difference from the embodiment according to FIG. 1 consists in that, in the present case, the sealing element 5 is arranged in a holding structure which is configured on the outside of the inner pipe 2 and assumes the form of a (further) holding bead. Said holding structure consists in part of the abovementioned fastening structure 2c for the spring element 4, which fastening structure 2c merely also comprises a further, third bulge 2f which is arranged in such a way that the sealing element 5 is to be arranged between the bulge 2e and the bulge 2f.

FIG. 4 shows another embodiment of the plug-type connection 1, which embodiment correspond substantially to a combination of the embodiments according to FIG. 2 and FIG. 3.

Whereas, in FIG. 4, the spring element 4 and the engagement structure 3b are configured approximately as has been described further above on the basis of FIG. 2, the inner pipe 2 is approximately configured as described further above on the basis of FIG. 3. This relates, in particular, to the arrangement of the sealing element 5.

As is also gathered from FIG. 4, the spring element 4 can be configured differently in the second portion 4b with a notch 4d, which notch 4d engages in a positively locking manner into the engagement structure 3b, as shown.

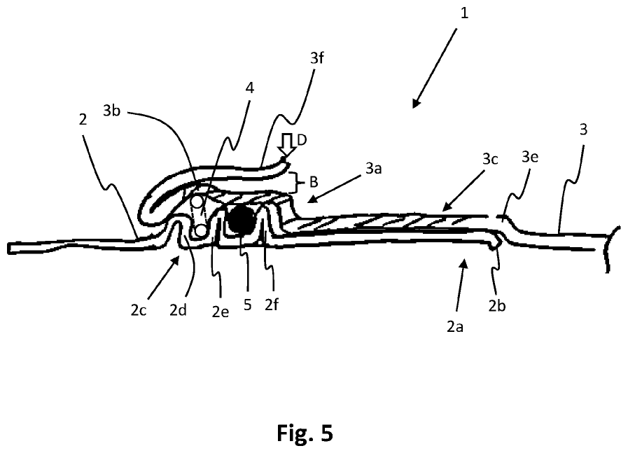

Finally, FIG. 5 also shows an embodiment which, with regard to the embodiment of the inner pipe 2, corresponds substantially to the embodiment according to FIGS. 3 and 4, which relates, in particular, to the arrangement of the sealing element 5. With regard to the spring element 4, the embodiment corresponds approximately to the embodiment in FIG. 1.

One deviation arises, in particular, in the region of the outer pipe 3. This is bent back axially onto itself at designation 3f, a radial spacing B remaining between a relevant bent-back portion 3f of the outer pipe 3 and a portion of the outer pipe 3 which lies radially further to the inside. The bulge at designation 3b serves as a type of bearing, with the result that, in the case of the action of, in particular, manual pressure according to the arrow D on the back formation 3f, the outer pipe 3 opens or widens at its end, with the result that the plug-type connection 1 can be released.

If, as shown in FIG. 5, the outer pipe 3 engages behind the terminal bulge 2d of the inner pipe 2, the separate spring element 4 can fundamentally be dispensed with because then, as it were, the outer pipe 3 acts with its indicated end in itself as a spring element.

1. A plug-type connection (1), comprising:
an inner pipe (2);
an outer pipe (3) that is plugged with one end thereof onto one end of the inner pipe (2);
a spring element (4) arranged on an outside of the inner pipe (2) in a region of said one end;
the outer pipe (3) has a first widened portion (3a) at said one end of the outer pipe, such that the outer pipe (3) is spaced apart (A) from the inner pipe (2) in a region of the first widened portion (3a) and engages over the spring element (4); and
the outer pipe (3) has an engagement structure (3b) in the region of the first widened portion (3a), and the spring element (4) is in engagement with the engagement structure (3b).

2. The plug-type connection (1) as claimed in claim 1, wherein, in the region of said end of the inner pipe, the inner pipe (2) has an outer fastening structure (2c) for fastening the spring element (4).

3. The plug-type connection (1) as claimed in claim 2, wherein the fastening structure (2c) comprises at least one holding bead.

4. The plug-type connection (1) as claimed in claim 3, wherein the at least one holding bead is configured toward an inside in the radial direction.

5. The plug-type connection (1) as claimed in claim 3, wherein the at least one holding bead is configured toward an outside in the radial direction.

6. The plug-type connection (1) as claimed in claim 2, wherein the spring element (4) is latched elastically into the fastening structure (2c).

7. The plug-type connection (1) as claimed in claim 1, wherein the spring element (4) is bent over axially in a connected state of the inner pipe (2) and the outer pipe (3).

8. The plug-type connection (1) as claimed in claim 1, further comprising a sealing element (5) arranged between the inner pipe (2) and the outer pipe (3).

9. The plug-type connection (1) as claimed in claim 8, wherein the sealing element (5) is received in a peripheral shaped-out formation (3d) of the outer pipe (3), said shaped-out formation (3d) is arranged outside the first widened portion (3a), in a region of a second widened portion (3c).

10. The plug-type connection (1) as claimed in claim 9, wherein an internal diameter of the outer pipe (3) in the region of the second widened portion (3c) corresponds substantially to an external diameter of the inner pipe (2).

11. The plug-type connection (1) as claimed in claim 8, wherein the sealing element (5) is arranged in a holding structure which is configured on the inner pipe (2).

12. The plug-type connection (1) as claimed in claim 8, wherein, in the region of said end of the inner pipe, the inner pipe (2) has an outer fastening structure (2c) for fastening the spring element (4), the fastening structure (2c) comprises at least one holding bead, and the holding structure is formed in part by the fastening structure (2c).

13. The plug-type connection (1) as claimed in claim 1, wherein the engagement structure (3b) comprises an aperture in the outer pipe (3).

14. The plug-type connection (1) as claimed in claim 1, wherein the engagement structure (3b) is configured as a radial bulge of the outer pipe (3).

15. The plug-type connection (1) as claimed in claim 1, wherein the spring element (14) protrudes axially beyond the outer pipe (3).

16. The plug-type connection (1) as claimed in claim 15, wherein in the region of said end of the inner pipe, the inner pipe (2) has an outer fastening structure (2c) for fastening the spring element (4), and the spring element (4) has, starting from the fastening structure (2c), a first portion (4a) with a radial course, followed by a second portion (4b), said second portion (4b) being in engagement with the engagement structure (3b), and subsequently a third portion (4c), said third portion (4c) protruding out of the outer pipe (3), the spring element (4) being arranged such that a movement of the third portion (4c) in a direction of the inner pipe (2) frees the second portion (4b) from engagement with the engagement structure (3b).

17. The plug-type connection (1) as claimed in claim 1, wherein the outer pipe (3) is pushable with said end thereof onto said end of the inner pipe (2) in the axial direction, with the spring element (4) being bent over in the axial direction and, when a connected state of the outer pipe (3) and the inner pipe (2) is achieved, forming an elastically joinable snap-action connection with a positively locking connection in conjunction with the engagement structure (3b).

18. The plug-type connection (1) as claimed in claim 1, wherein the inner pipe (2) terminally has an insertion bevel (2b) at said one end thereof.

19. The plug-type connection (1) as claimed in claim 1, wherein the inner pipe (2) and the outer pipe (3) are formed from a metallic material.

20. The plug-type connection (1) as claimed in claim 1, wherein the outer pipe (3) is terminally bent back on itself axially at said one end thereof, with a radial spacing (B) remaining between a bent-back portion (3f) of the outer pipe (3) and a portion of the outer pipe (3).
